(19) United States
(12) Patent Application Publication
(10) Pub. No.: US 2008/0283798 A1
(43) Pub. Date: Nov. 20, 2008

(54) METHOD AND DEVICE FOR GENERATING HYDROGEN FROM SUBSTANCES CONTAINING GLYCEROL

(75) Inventors: Axel BEHRENS, Muenchen (DE); Heinz Boelt, Wolfratshausen (DE); Peter Matthias Fritz, Unterhaching (DE); Wibke Korn, Krailing (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Munich (DE)

(21) Appl. No.: 11/928,969

(22) Filed: Oct. 30, 2007

(30) Foreign Application Priority Data
Oct. 31, 2006 (DE) 10 2006 051 262.6
Jan. 30, 2007 (DE) 10 2007 004 626.1
May 16, 2007 (DE) 10 2007 022 962.5

(51) Int. Cl. C01B 3/22

(52) U.S. Cl. 252/373; 422/189; 422/187

(57) ABSTRACT

A method for producing at least one product stream containing hydrogen from a feedstock containing glycerol and a device for performing the method is disclosed. By separation of unwanted substances and pyrolysis of glycerol, an intermediate product is obtained from the feedstock containing glycerol and is then converted into a crude synthesis gas containing hydrogen and carbon monoxide by steam reforming in an externally heated steam reforming reactor.

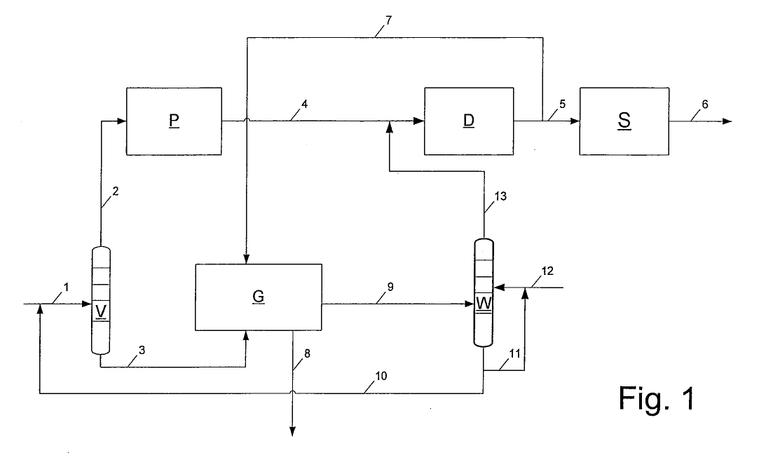

This application claims the priority of German Patent Document Nos. 10 2006 051 262.6, filed Oct. 31, 2006, 10 2007 004 626.1, filed Jan. 30, 2007, and 10 2007 022 962.5, filed May 16, 2007, the disclosures of which are expressly incorporated by reference herein.

### BACKGROUND AND SUMMARY OF THE INVENTION

The present invention relates to a method for generating a product stream containing at least hydrogen from a feedstock containing glycerol as well as a device for performing the method.

In an effort to lower the carbon dioxide emissions into the earth's atmosphere or at least to prevent a further increase in emissions, and as alternatives to diminishing petroleum and natural gas reserves, energy sources from renewable raw materials will be used to a greater extent in the future. According to an EU guideline, at least 5.75% of the fuel consumption in the European Union should be covered by such energy sources by the year 2010. Biodiesel, which is already being added today to the diesel fuel available at German service stations in a concentration of up to 5%, plays an important role here.

Biodiesel is a standardized fuel obtained mainly from canola oil, but also from other vegetable fats and oils. Vegetable fats and oils consist of triglycerides, i.e., three fatty acids bound to glycerol. Because of this structure, vegetable fats and oils are viscous to solid at normal ambient temperatures, i.e., they have a much higher viscosity than the fuels for which a conventional diesel engine today is designed. Vegetable fats and oils behave differently in the injection process and combustion is also not as clean. These disadvantages can be compensated only incompletely by measures involving the engine—such as preheating the vegetable oil, for example.

Biodiesel is obtained from vegetable fats and oils by replacing the glycerol with methanol. Its viscosity corresponds to that of commercial diesel fuel, which is why it can also be burned even in unmodified diesel engines with no problem.

The glycerol separated from the vegetable fats and oils in biodiesel production is not obtained in pure form but instead is obtained as part of substance mixtures containing large amounts of impurities in addition to glycerol. Such a substance mixture would include, for example, so-called crude glycerol, which has a glycerol content of 80 to 85% but also contains water and salts in large amounts as well as residues from the production process. According to the state of the art, crude glycerol is purified in complex process steps such as vacuum distillation, deodorization and filtration to such an extent that it complies with the strict requirements of the European Pharmacopoeia and can be sold to the pharmaceutical industry as pharmaceutical grade glycerol with a purity of at least 99.5%. At the present point in time, all the glycerol produced in biodiesel production can be utilized in this way. With the foreseeable expansion of biodiesel production, this will become increasingly difficult in the future, so that other pathways for utilization of crude glycerol must be sought.

The object of the present invention is therefore to provide a method of the generic type which will make it possible to send the byproducts containing glycerol obtained in biodiesel production for economical utilization.

This object is achieved by a method according to this invention in which an intermediate product is obtained from a feedstock containing glycerol by separation of unwanted substances and then pyrolysis of glycerol, the intermediate then being converted to a crude synthesis gas containing hydrogen and carbon monoxide by steam reforming in an externally heated steam reforming reactor (steam reformer).

According to a preferred variant of the inventive method, the crude synthesis gas generated by steam reforming is subjected to a water-gas shift, in which preferably all the carbon monoxide contained in the crude synthesis gas is reacted with water to yield hydrogen and carbon dioxide.

The energy consumption of the inventive method is influenced significantly by the amount of water to be heated in the steam reformer: the greater the amount of water, the higher the energy demand. To optimize the energy demand of the inventive method, the feedstock supplied to the steam reformer therefore logically has only a minimum water content, the amount of which is determined by the downstream process steps.

The minimum water content is derived from the requirement that the formation of soot in the steam reformer must be suppressed completely, while at the same time enough water remains in the crude synthesis gas to be able to perform the process steps after steam reforming (e.g., a water-gas shift) in which water is consumed without having to add water. Therefore, the water content and/or the water vapor content of the intermediate product is advantageously adjusted to the minimum water content by adding or removing water and/or water vapor before steam reforming.

The invention is based on the finding that in direct utilization of feedstocks containing glycerol, e.g., crude glycerol, by gasification and/or steam reforming, problems occur because of the high level of impurities present in the feedstock, but these problems can be overcome only with great complexity or not at all. For example, salts lead to corrosion of installation parts and to premature deactivation of catalysts. Organic impurities are also difficult to control and may lead to deposits and the formation of soot.

According to one embodiment of the inventive method, separation of unwanted substances (already present in the feedstock and/or produced in performing the inventive method) and pyrolysis of glycerol are performed simultaneously in one process step.

According to another embodiment of the inventive method, an intermediate product is obtained from the feedstock in at least two successive process steps, unwanted substances being separated in each of the process steps and/or glycerol being converted by pyrolysis. If the second process step is a simple pyrolysis (without separation of unwanted substances), then according to a preferred variant of the inventive method, pyrolysis is performed in the so-called convection zone of the steam reformer, which to this end is designed as a pyrolysis reactor.

To separate unwanted substances present in the feedstock, according to this invention, the feedstock is preferably subjected to distillation and/or thermal drying and/or filtering through activated carbon and/or a membrane and/or by chromatography and/or ion exchange and/or ion exclusion.

The water and/or water vapor content in the fraction containing glycerol obtained by separation of unwanted substances from the feedstock is preferably adjusted by adding or removing water and/or water vapor to a level which allows a subsequent pyrolysis to be performed without any production of soot and with minimal energy input at the same time. According to another embodiment of the inventive method, the water required for pyrolysis is to be supplied in more than one step (stepwise), the water being supplied at a suitable location before and/or during pyrolysis. If pyrolysis is performed in several successive steps (pyrolysis steps) then the water is expediently added before a pyrolysis step.

If the fraction containing glycerol is sent in liquid form for pyrolysis, water is preferably supplied in the form of water vapor, the water vapor being sprayed into the fraction containing glycerol or the fraction containing glycerol being sprayed into the water vapor. A considerable portion of the energy required for the subsequent pyrolysis is introduced with the water vapor, which leads to a reduced heating complexity in the pyrolysis reactor and thus to a reduction in equipment complexity for the pyrolysis reactor.

Thermal drying is understood to mean that the feedstock is introduced into a thermal drying unit, where it is subjected to a thermal treatment. Volatile constituents such as water and glycerol are evaporated and form a gas fraction together with other gaseous substances under some circumstances, whereas solids such as salts are converted to a largely anhydrous solid fraction. The solid fraction and the gas fraction are then removed mostly separately from the thermal drying unit, which is therefore equipped with a suitable device for separating dust and gas, e.g., a gravity separator and/or a cyclone and/or a filter device and/or a water scrubber.

At sufficiently high temperatures, glycerol undergoes thermal decomposition, i.e., pyrolysis. In a further embodiment of the inventive method, it is therefore provided that thermal drying of the feedstock is performed at temperatures at which the glycerol contained in the feedstock is at least partially converted by pyrolysis. Depending on how much of the glycerol is pyrolyzed in thermal drying, the gas fraction is then subjected to further pyrolysis following thermal drying or is sent directly for steam reforming.

According to an advantageous embodiment of the inventive method, the heat required for thermal drying of the feedstock is removed from a hot gas stream, the temperature of which is between 100° C. and 1,000° C., preferably between 100° C. and 250° C., and which is preferably a synthesis gas stream branching off directly after steam reforming. If the heat is transferred in indirect heat exchange from a crude synthesis gas stream to the feedstock, then the cooled crude synthesis gas stream is advantageously recycled again after steam reforming and fed into the crude synthesis gas stream.

Thermal drying of the feedstock is preferably performed by using fluidized bed granulators and/or fluidized bed dryers and/or rotary dryers and/or fluidized bed dryers and/or suspension dryers and/or paste dryers are used.

According to variants of the inventive method, pyrolysis is performed by supplying water and/or steam and/or an oxidizing agent, where the oxidizing agent is air or oxygen or air enriched with oxygen.

According to additional variants of the inventive method, the intermediate product obtained from the feedstock by separation of unwanted substances and pyrolysis jointly with a suitable oxidizing agent, which may be air or oxygen or air enriched with oxygen, is sent for steam reforming, preferably with catalytic support.

Depending on the method selected for separating unwanted substances from the feedstock, an aqueous mixture (wastewater) containing the separated substances in dissolved and/or suspended form may be obtained when performing the inventive method, but the substances cannot be utilized without further treatment. This wastewater is a waste product that must be sent as special waste to a dump. To minimize dumping costs, the goal is to keep the volume of waste to be dumped as small as possible. According to one embodiment of the inventive method, the wastewater is subjected to a treatment which reduces the volume of waste to be dumped. The wastewater is preferably subjected to drying in a thermal drying unit, yielding a gas fraction and a solid fraction that is largely free of water. In the best case, the solid fraction thereby obtained can be utilized economically (e.g., as fertilizer) so that the waste volume to be dumped drops to zero.

According to an advantageous embodiment of the inventive method, the heat required for thermal drying of wastewater is withdrawn from a hot gas stream having a temperature between 100° C. and 1,000° C., preferably between 100° C. and 250° C., preferably a crude synthesis gas stream branching off directly after steam reforming. Because of the heat transferred from the hot gas stream to the wastewater, the volatile constitutes are transferred from the wastewater into the gas phase, thereby producing a gas fraction and a largely anhydrous solid fraction, the latter being in the form of granules or powder, for example, after the drying method.

If the hot gas stream used for thermal drying of wastewater is a hot crude synthesis gas stream and if the heat is transferred to the wastewater to be dried by direct heat exchange, then according to a further embodiment of the inventive method, the gas fraction created by drying is subjected to a water scrubbing, preferably in a water scrubbing apparatus, then is recycled upstream from the steam reformer and supplied to the latter as feedstock. The loaded scrubbing water is expediently removed from the water scrubbing apparatus and mixed with the feedstock containing glycerol.

Fluidized bed granulators and/or fluidized bed dryers and/or rotary dryers and/or fluidized bed dryers and/or suspension dryers and/or paste dryers are preferably used for thermal drying of wastewater.

The invention also relates to a device for performing the inventive method.

In terms of equipment, the object formulated here is achieved by arranging in succession a pyrolysis apparatus in which an intermediate product can be generated from the feedstock by separating impurities and by pyrolysis of the glycerol contained in the feedstock and then an externally heated steam reforming reactor (steam reformer) in which a crude synthesis gas containing hydrogen and carbon monoxide can be produced from the intermediate product generated in the pyrolysis apparatus.

In a preferred embodiment of the inventive device, the pyrolysis apparatus consists of a thermal drying unit in which a solid fraction that is free of gas and is largely free of water can be produced from the feedstock, whereby any glycerol present in the gas fraction is at least partially pyrolyzed at the temperatures prevailing in the thermal drying unit. Expediently the thermal drying unit comprises a suitable apparatus for separating dust from the gas fraction so that a largely dust-free intermediate product can be produced and can be sent to the steam reformer. The thermal drying unit is preferably a fluidized bed granulator and/or a fluidized bed dryer and/or a rotary dryer and/or a fluidized bed dryer and/or a suspension dryer and/or a paste dryer. Those skilled in the art have been familiar with such thermal drying units for many years and they are also available on the market.

According to another preferred embodiment of the inventive method, the pyrolysis apparatus comprises a cleaning unit and a downstream pyrolysis reactor, whereby a pyrolysis feedstock can be produced in the cleaning apparatus from the feedstock by separation of impurities, this pyrolysis feedstock being convertible to an intermediate product by pyrolysis in the pyrolysis reactor. According to this invention, the cleaning apparatus is preferably designed as a vacuum distillation apparatus and/or a thermal drying unit and/or a filter apparatus with activated carbon or a membrane and/or a chromatography apparatus and/or an ion exchanger and/or ion exclusion equipment.

According to an expedient embodiment of the inventive device, it is a suitable apparatus with which the water and/or water vapor content of the fraction containing the glycerol obtained from the feedstock by separation of unwanted substances can be adjusted to a level that is favorable for conducting downstream pyrolysis by adding or removing the water and/or water vapor. According to another embodiment of the inventive device, it comprises a suitable apparatus with which water needed for pyrolysis can be supplied in more than one step (stepwise) upstream from the pyrolysis reactor and/or at a suitable location in the pyrolysis reactor. If pyrolysis is performed in multiple reactors arranged in series, water may expediently be added upstream from each pyrolysis reactor.

If the fraction containing glycerol is supplied in liquid form for pyrolysis, then the inventive device preferably comprises an apparatus for mixing water vapor with the fraction containing glycerol (mixer), whereby water vapor may be sprayed into the fraction containing glycerol or the fraction containing glycerol may be sprayed into the water vapor. In an effort to design the mixer to be as compact as possible, a nozzle may be provided at a suitable location, for example, to spray the glycerol fraction containing glycerol as a fine mist into the highly turbulent flow of water vapor. A substantial portion of the energy required for the downstream pyrolysis is introduced with the water vapor, thus leading to a reduced heating demand in the pyrolysis reactor and to a reduction in the equipment required for the pyrolysis reactor.

The steam reformer is preferably a tubular reactor of the type with which those skilled in the art have been familiar for many years, such as those also used for steam reforming of methane. The feedstock materials are carried in pipes through the steam reformer, where they are preheated first in the so-called convection zone before being reacted catalytically in the downstream so-called radiation zone. Preferred embodiments of the inventive device have the steam reformer containing a catalyst material comprising nickel (Ni) or platinum (Pt) or palladium (Pd) or iron (Fe) or rhodium (Rh) or ruthenium (Ru) or iridium (Ir) or containing Ni and/or Pt and/or Pd and/or Fe and/or Rh and/or Ru and/or Ir. The catalyst material is especially preferably a catalyst material also suitable for catalytically supported steam reforming of naphtha or methane.

According to a further embodiment of the inventive device, the pyrolysis reactor and a steam reformer form one structural unit. The convection zone of the steam reformer is expediently designed as a pyrolysis reactor.

According to an advantageous variant of the inventive device, an apparatus is used for reducing the water content of an aqueous mixture (wastewater) that cannot be used further substantively and is obtained in purification of the feedstock containing glycerol. This apparatus is preferably a thermal drying unit such as a fluidized bed granulator and/or a fluidized bed dryer and/or a rotary dryer and/or a fluidized bed dryer and/or a suspension dryer and/or a paste dryer. Such thermal drying units are available on the market and those skilled in the art have been familiar with them for many years. The thermal drying is expediently designed so that a largely anhydrous solid fraction and a largely dust-free gas fraction can be obtained from the wastewater.

If the thermal drying unit is a unit in which energy can be supplied to wastewater that is to be dried in direct contact with hot crude synthesis gas, then according to an advantageous embodiment of the inventive device, a water scrubbing apparatus is provided into which the gas stream loaded with dust emerging from the thermal drying unit can be freed of dust by water scrubbing before being recycled as feedstock back to the steam reformer. The loaded scrub water can expediently be removed from the water scrubber and added to the crude glycerol.

### BRIEF DESCRIPTION OF THE DRAWING

The FIGURE illustrates an embodiment of a method and device in accordance with the principles of the present invention.

### DETAILED DESCRIPTION OF THE DRAWING

The present exemplary embodiment relates to an installation for producing a product gas containing mainly hydrogen, using crude glycerol from biodiesel production as the feedstock consisting of approximately 85% glycerol plus small quantities of water and salt as well as residual substances from the production process.

The crude glycerol is introduced through line 1 into the vacuum distillation apparatus V, where it is separated into the two substance streams 2 and 3. Then stream 2, consisting almost exclusively of glycerol, is sent as a feedstock to the pyrolysis reactor P, where it is converted to a pyrolysis product. The pyrolysis product is removed from the pyrolysis reactor P through line 4 and sent to the steam reformer D, where it is converted with catalytic support into a crude synthesis gas containing mostly hydrogen and carbon monoxide. The crude synthesis gas containing mostly hydrogen and carbon monoxide is withdrawn from the steam reformer D through line 5 and sent to the shift reactor S. A product gas containing mostly hydrogen is removed through line 6 from the shift reactor S, in which most of the carbon monoxide is reacted with water to form carbon dioxide and hydrogen and then sent for workup (not shown). The substance stream 3 from the vacuum distillation apparatus V consisting mainly of water and salts as well as residual substances from biodiesel production is sent to granulator G, where it is dried by means of the hot crude synthesis gas stream 7 that is branched off downstream from the steam reformer D. The salts contained in the substance stream 3 and other solids are converted to granules and removed from the granulator G through line 8. A substance stream consisting mainly of gases and vapors but also containing solids in dust form is removed through line 9 and sent to the water scrubbing apparatus W, where it is cleaned. A portion of the loaded scrubbing water from the water scrubbing apparatus W is withdrawn through line 10 and sent jointly with the crude glycerol through line 1 into the vacuum distillation apparatus V, while the other portion 11 is mixed with fresh water 12 and recycled as scrubbing water into the scrubbing water apparatus W. A substance stream consisting mainly of crude synthesis gas and water vapor is withdrawn from the water scrubbing apparatus W and sent jointly with the pyrolysis product 4 to the steam reformer D.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing at least one product stream containing hydrogen from a feedstock containing glycerol, wherein an intermediate product is obtained from the feedstock containing glycerol by separation of unwanted substances and pyrolysis, the intermediate product then being converted to a crude synthesis gas containing hydrogen and carbon monoxide by steam reforming in an externally heated steam reforming reactor.

2. The method according to claim 1, wherein the separation of unwanted substances and pyrolysis of glycerol are performed simultaneously in one process step.

3. The method according to claim 1, wherein the intermediate product is obtained from the feedstock in at least two successive process steps, unwanted substances being separated in each of the process steps and/or glycerol being reacted by pyrolysis.

4. The method according to claim 3, wherein the pyrolysis is performed in a convection zone of the steam reforming reactor.

5. The method according to claim 1, wherein the pyrolysis is performed by supplying water and/or steam and/or an oxidizing agent and wherein the oxidizing agent is air or oxygen or air enriched with oxygen.

6. The method according to claim 1, wherein unwanted substances present in the feedstock are removed by distillation and/or thermal drying and/or filtering through activated carbon and/or a membrane and/or by chromatography and/or ion exchange and/or ion exclusion.

7. The method according to claim 6, wherein the thermal drying of the feedstock is performed at temperature at which first there is a partial conversion of the glycerol contained in the feedstock by pyrolysis.

8. The method according to claim 1, wherein an aqueous mixture obtained in the separation of unwanted substances from the feedstock and containing separated substances in dissolved and/or suspended form is subjected to drying in a thermal drying unit, producing a largely anhydrous solid fraction and a gas fraction.

9. A device for producing at least one product stream containing hydrogen from a feedstock containing glycerol, comprising, arranged one after another, a pyrolysis apparatus in which an intermediate product is produced from the feedstock by separation of impurities and pyrolysis of the glycerol contained in the feedstock, and an externally heated steam reforming reactor in which a crude synthesis gas containing hydrogen and carbon monoxide is produced from the intermediate product produced in the pyrolysis apparatus.

10. The device according to claim 9, wherein the pyrolysis apparatus consists of a thermal drying unit in which a gas fraction and a largely anhydrous solid fraction is produced from the feedstock, wherein glycerol present in the gas fraction due to temperatures prevailing in the thermal drying unit is at least partially pyrolyzed.

11. The device according to claim 9, wherein the pyrolysis apparatus comprises a cleaning apparatus and a downstream pyrolysis reactor, wherein a pyrolysis feedstock which is produced from the feedstock in the cleaning apparatus by separation of impurities is converted into the intermediate product by pyrolysis in the pyrolysis reactor.

12. The device according to claim 11, wherein the pyrolysis reactor and the steam reforming reactor form a structural unit, a convection zone of the steam reforming reactor designed as the pyrolysis reactor.

13. The device according to claim 11, wherein the cleaning apparatus is a vacuum distillation apparatus and/or a thermal drying unit and/or a filter device with activated carbon or a membrane and/or a chromatography apparatus and/or an ion exchanger and/or an ion exclusion device.

14. The device according to claim 9, wherein the steam reforming reactor contains a catalyst material comprising nickel (Ni) or platinum (Pt) or palladium (Pd) or iron (Fe) or rhodium (Rh) or ruthenium (Ru) or iridium (Ir) or containing Ni and/or Pt and/or Pd and/or Fe and/or Rh and/or Ru and/or Ir.

15. The device according to claim 14, wherein the steam reforming reactor is a tubular reactor with a convection zone and a radiation zone.

16. The device according to claim 9, further comprising an apparatus for reducing a water content of an aqueous wastewater mixture, the aqueous wastewater mixture obtained in purification of the feedstock containing glycerol.

17. An apparatus for producing a product stream containing hydrogen from a feedstock containing glycerol, comprising:
a pyrolysis apparatus, wherein an intermediate product is produced from the feedstock by separation of impurities and pyrolysis of the glycerol contained in the feedstock; and
an externally heated steam reforming reactor, wherein a crude synthesis gas containing hydrogen and carbon monoxide is produced from the intermediate product produced in the pyrolysis apparatus.

18. The apparatus according to claim 17, wherein the feedstock is crude glycerol from a biodiesel production process.

19. The apparatus according to claim 17, wherein the pyrolysis apparatus includes a thermal drying unit, wherein the thermal drying unit produces a solid fraction and a gas fraction from the feedstock, and wherein the gas fraction is pyrolyzed in the thermal drying unit to produce the intermediate product.

20. The apparatus according to claim 17, wherein the pyrolysis apparatus includes a cleaning unit and a pyrolysis reactor downstream from the cleaning unit, wherein the cleaning unit produces a pyrolysis feedstock by separating the impurities from the feedstock, and wherein the pyrolysis reactor produces the intermediate product from the pyrolysis feedstock by pyrolysis.
